(19) United States
(12) Patent Application Publication
(10) Pub. No.: US 2024/0196022 A1
(43) Pub. Date: Jun. 13, 2024

(54) Live Room Video Playback

(71) Applicant: Shanghai Bilibili Technology Co., Ltd., Shanghai (CN)

(72) Inventor: Lulu JIANG, Shanghai (CN)

(21) Appl. No.: 18/444,863

(22) Filed: Feb. 19, 2024

Related U.S. Application Data
(63) Continuation of application No. PCT/CN2022/097807, filed on Jun. 9, 2022.

(30) Foreign Application Priority Data
Nov. 4, 2021 (CN) 202111298485.3

(51) Int. Cl. H04N 21/2187; H04N 21/431; H04N 21/472

(52) U.S. Cl. CPC H04N 21/2187; H04N 21/4316; H04N 21/47217

(57) ABSTRACT

This application discloses a live room video playback method. The method includes: in response to detecting that a user enters a live room playback page, pulling a live video stream corresponding to a live room from a preset livestreaming server; creating a first video player and a second video player, setting an attribute of the first video player to a normal playback mode, and setting an attribute of the second video player to an abnormal playback mode; decoding and playing the live video stream by using the first video player in the normal playback mode, and decoding and playing the live video stream by using the second video player in the abnormal playback mode; and in response to detecting a live room playback page exit instruction triggered by the user, destroying the first video player, and decoding and playing the live video stream by using the second video player in a floating window mode and the normal playback mode.

### CROSS-REFERENCE TO RELATED APPLICATIONS

The present application is a continuation under 35 U.S.C. 111(a) of PCT International Application No. PCT/CN2022/097807, filed on Jun. 9, 2022, which claims priority to Chinese Patent Application No. 202111298485.3, filed on Nov. 4, 2021, the entire contents of which are hereby incorporated by reference in their entirety for all purposes.

### TECHNICAL FIELD

This application relates to the field of video technologies, and in particular, to a method, a computing device, and a non-transitory computer-readable storage medium.

### BACKGROUND

With development of Internet technologies and popularization of mobile terminals, the livestreaming industry also develops rapidly. Increasingly more persons view live videos in live rooms by using livestreaming clients.

### SUMMARY

According to a first aspect of the embodiments of this application, a method is provided, including:
in response to detecting that a user enters a live room playback page, pulling a live video stream corresponding to a live room from a preset livestreaming server;
creating a first video player and a second video player, setting an attribute of the first video player to a normal playback mode, and setting an attribute of the second video player to an abnormal playback mode, where the abnormal playback mode is that the second video player silently plays in background;
decoding and playing the live video stream by using the first video player in the normal playback mode, and decoding and playing the live video stream by using the second video player in the abnormal playback mode; and
in response to detecting a live room playback page exit instruction triggered by the user, destroying the first video player, and decoding and playing the live video stream by using the second video player in a floating window mode and the normal playback mode.

According to a second aspect of the embodiments of this application, a computing device is provided, including:
one or more processors; and
a memory, storing one or more programs configured to be executed by the one or more processors, the one or more programs including instructions for:
in response to detecting that a user enters a live room playback page, pulling a live video stream corresponding to a live room from a preset livestreaming server;
creating a first video player and a second video player, setting an attribute of the first video player to a normal playback mode, and setting an attribute of the second video player to an abnormal playback mode, wherein the abnormal playback mode is that the second video player silently plays in a background;
decoding and playing the live video stream by using the first video player in the normal playback mode, and decoding and playing the live video stream by using the second video player in the abnormal playback mode; and
in response to detecting a live room playback page exit instruction triggered by the user, destroying the first video player, and decoding and playing the live video stream by using the second video player in a floating window mode and the normal playback mode.

According to a third aspect of the embodiments of this application, a non-transitory computer-readable storage medium is provided, where the non-transitory computer-readable storage medium stores one or more programs including instructions that, when executed by one or more processors of a computing device, cause the computing device to perform operations including:
in response to detecting that a user enters a live room playback page, pulling a live video stream corresponding to a live room from a preset livestreaming server;
creating a first video player and a second video player, setting an attribute of the first video player to a normal playback mode, and setting an attribute of the second video player to an abnormal playback mode, wherein the abnormal playback mode is that the second video player silently plays in a background;
decoding and playing the live video stream by using the first video player in the normal playback mode, and decoding and playing the live video stream by using the second video player in the abnormal playback mode; and
in response to detecting a live room playback page exit instruction triggered by the user, destroying the first video player, and decoding and playing the live video stream by using the second video player in a floating window mode and the normal playback mode.

### BRIEF DESCRIPTION OF THE DRAWINGS

FIG. 1 is a schematic diagram of an environment of a live room video playback method according to some embodiments of this application;

FIG. 2 is a flowchart of some embodiments of a live room video playback method according to this application;

FIG. 3a to FIG. 3c are schematic diagrams of a process of enabling a floating window mode according to an implementation of this application;

FIG. 4 is a schematic flowchart of detailed steps of destroying a first video player when a live room playback page exit instruction triggered by a user is detected, and decoding and playing a live video stream by using a second video player in a floating window mode and a normal playback mode according to an implementation of this application;

FIG. 5 is a flowchart of some embodiments of a live room video playback method according to this application;

FIG. 6 is a program means diagram of some embodiments of a live room video playback apparatus according to this application; and

FIG. 7 is a schematic diagram of a hardware structure of a computer device that performs a live room video playback method according to some embodiments of this application.

### DESCRIPTION OF EMBODIMENTS

The following further describes the advantages of this application with reference to the accompanying drawings and embodiments.

The example embodiments are described in detail herein and the examples are shown in the accompanying drawings. When the following descriptions relate to the accompanying drawings, unless otherwise specified, a same number in different accompanying drawings represents a same or similar element. The implementations described in the following example embodiments do not represent all implementations consistent with this disclosure. On the contrary, they are only examples of apparatuses and methods that are described in the appended claims in detail and that are consistent with some aspects of this disclosure.

The terms used in this disclosure are merely used to describe embodiments, and are not intended to limit this disclosure. The terms “a”, “said”, and “the” of singular forms used in this disclosure and the appended claims are also intended to include plural forms, unless otherwise specified in the context clearly. It should be further understood that the term “and/or” used in this specification indicates and includes any or all possible combinations of one or more associated listed items.

It should be understood that although terms “first”, “second”, “third”, and the like may be used in this disclosure to describe various types of information, the information is not limited by these terms. These terms are merely used to distinguish between information of a same type. For example, without departing from the scope of this disclosure, first information may also be referred to as second information. Similarly, the second information may also be referred to as the first information. Depending on the context, for example, the word “if” used herein can be interpreted as “while”, “when”, or “in response to determining”.

In the descriptions of this application, it should be understood that numerical symbols before steps do not indicate a sequence of performing the steps, but are merely used to facilitate description of this application and differentiation of each step, and therefore cannot be construed as a limitation on this application.

The inventor finds that when a user views a live video in a live room by using a terminal device with an iOS version, if the user exits the live room at this time, the user cannot continue to view the live video, resulting in poor user experience.

In some embodiments, the method includes: pulling a live video stream corresponding to a live room from a preset livestreaming server when it is detected that a user enters a live room playback page; creating a first video player and a second video player, setting an attribute of the first video player to a normal playback mode, and setting an attribute of the second video player to an abnormal playback mode, where the abnormal playback mode is that the second video player silently plays in the background; decoding and playing the live video stream by using the first video player in the normal playback mode, and decoding and playing the live video stream by using the second video player in the abnormal playback mode; and destroying the first video player when a live room playback page exit instruction triggered by the user is detected, and decoding and playing the live video stream by using the second video player in a floating window mode and the normal playback mode. In this application, two video players are simultaneously created when the video is played in the live room. The live video is played in the foreground by using one player, and the live video is played in the background by using the other player. In this way, when the user triggers a return to the system desktop, the live video can be continuously played in the foreground in the floating window mode by using the video player located in the background, improving user experience.

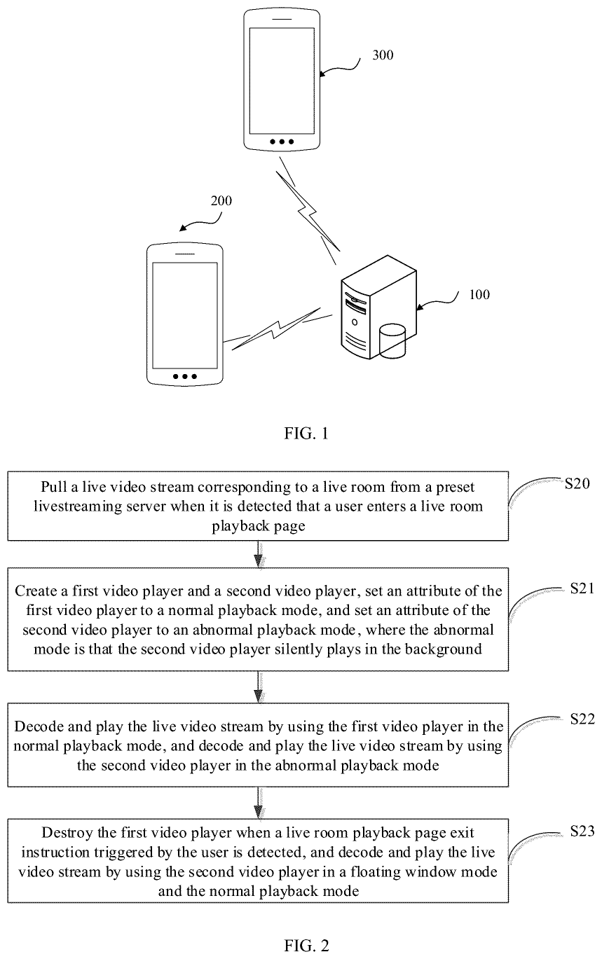

FIG. 1 is a schematic diagram of an application scenario according to some embodiments of this application. The application scenario includes a livestreaming server 100, an online streamer terminal 200, and a viewer terminal 300. The livestreaming server 100, the online streamer terminal 200, and the viewer terminal 300 are located in a wireless network or a wired network. The livestreaming server 100 may exchange data with the online streamer terminal 200 and the viewer terminal 300. In some implementations, a quantity of online streamer terminals 200 (only one shown in FIG. 1) and a quantity of viewer terminals 300 (only one shown in FIG. 1) may not be limited. The viewer terminal 300 and the online streamer terminal 200 may use the livestreaming server 100 as a transmission medium, and implement mutual data exchange through the Internet.

In the embodiments of this application, the livestreaming server 100 may be a separate server, a server cluster, a local server, or a cloud server. A type of the server may not be limited in the embodiments of this application. The online streamer terminal 200 and the viewer terminal 300 each may be a mobile phone, a smartphone, a notebook computer, a desktop computer, a tablet computer, a personal digital assistant (PDA), a media player, a smart television, a wearable electronic device, or the like. A type of the terminal device may not be limited in the embodiments of this application.

In the embodiments, a livestreaming client may be installed in the online streamer terminal 200, and the livestreaming client is used by an online streamer to implement video live streaming. The livestreaming client may be a computer application (APP) installed in the online streamer terminal 200, or may be a web client. The web client may be an application developed based on a web architecture.

In the embodiments, a viewer client may be installed in the viewer terminal 300, and the viewer client is used by a viewer to receive livestreaming content, and present the livestreaming content. The viewer client may be a computer application (APP) installed in the viewer terminal 300, or may be a web client. The web client may be an application developed based on the web architecture.

FIG. 2 is a schematic flowchart of a live room video playback method according to some embodiments of this application. The live room video playback method in this application may be applied to an iOS version of livestreaming APP. It may be understood that the flowchart in the method embodiments is not used to limit a step execution sequence. It can be learned from the figure that, the live room video playback method provided in the embodiments includes the following:

Step S20: Pull a live video stream corresponding to a live room from a preset livestreaming server when it is detected that a user enters a live room playback page.

In some embodiments, after enabling the livestreaming APP, the user may select one of a plurality of live rooms displayed on a live homepage and enter the live room to view a live video. When the user selects the live room and enters a live playback page of the selected live room to view the live video, the livestreaming APP pulls a live video stream of the live room from the preset livestreaming server, so that the livestreaming APP can decode and play the live video stream.

The livestreaming server is a server that stores live video streams of all live rooms. In the embodiments, the livestreaming APP may pull a live video stream of a current live room from the livestreaming server according to an address of the live video stream of the live room.

In an implementation, when the user enters the live room to view the video, the user may further select a floating window mode to play a video currently viewed by the user in the live room. In some embodiments, the user may tap a preset button on the live page to trigger an enable instruction of the floating window mode, or the user may execute a preset operation on the live page to trigger the enable instruction of the floating window mode. This is not limited in the embodiments.

In some scenarios, when the user needs to enable the floating window mode, the user may tap a floating window panel wakeup button in advance. After detecting a floating window panel wakeup instruction triggered by tapping the floating window panel wakeup button by the user, the livestreaming APP pops up a floating window panel on a page currently displayed by the livestreaming APP. Then, the user may tap a floating window button on the floating window panel to trigger the enable instruction of the floating window mode. Finally, when detecting the enable instruction of the floating window mode triggered by the user, the livestreaming APP plays the live video in the floating window mode.

It should be noted that the floating window panel in the embodiments includes at least the floating window button, and the floating window button is a button used to trigger the floating window mode.

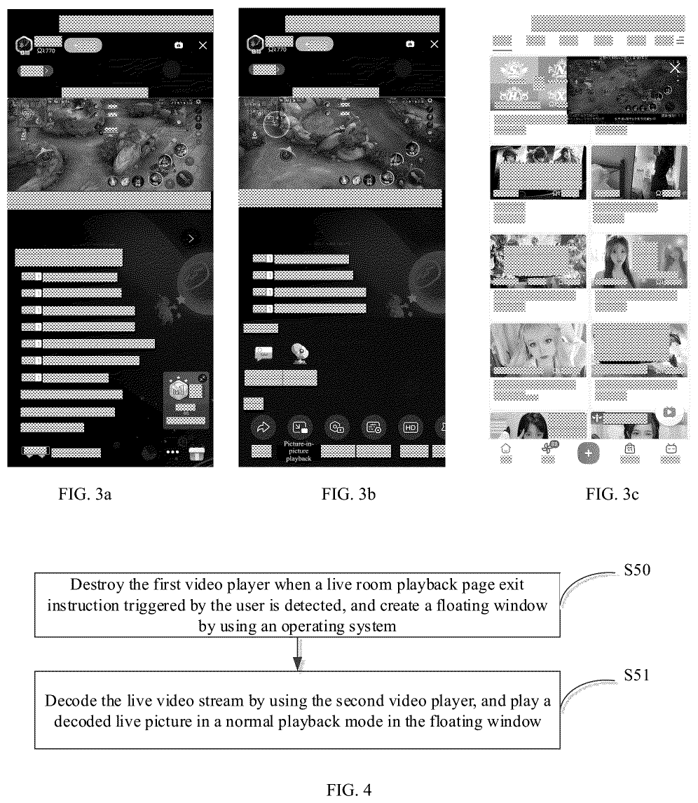

As an example, refer to FIG. 3a to FIG. 3c. When viewing the video in the live room, the user may first tap a “ . . . ” button (the floating window panel wakeup button) in FIG. 3a, to evoke the floating window panel. Then, the user may continue to tap a “picture-in-picture playback” button (the floating window button) in FIG. 3b, to trigger the enable instruction of the floating window mode. After the enable instruction of the floating window mode triggered by the user is detected, a series of processing operations are performed according to the instruction, to obtain a page shown in FIG. 3c.

The floating window mode is a video playback mode in which a live video is played in a floating window manner. Usually, the floating window mode may also be referred to as a picture-in-picture mode. The enable instruction is used to enable the floating window mode to play a video of a live room.

It should be noted that in the embodiments, when the user enters the live room to view the live video, the livestreaming APP creates a first video player to play the live video. The first video player is a video player that does not support video playback in a floating window mode, and the first video player is an ijkPlayer in some embodiments. ijkPlayer is an ffplay-based lightweight Android/iOS video player that is open sourced by bilibili.

Step S21: Create the first video player and a second video player, set an attribute of the first video player to a normal playback mode, and set an attribute of the second video player to an abnormal playback mode, where the abnormal playback mode is that the second video player silently plays in the background.

In some embodiments, the second video player is an AVPlayer. AVPlayer is a full-featured audio and video player that can play files in any format and is suitable for iPhone/iPod/iPad. A file may be transferred to the player by using iTunes or through Wi-Fi. Alternatively, a video file may be directly opened or a file may be downloaded from a server such as Ftp/Samba/UPnP by using a built-in download client. There is also a built-in photo browser for viewing photos.

The normal playback mode is that the player plays the live video with a normal sound at a normal frame rate in the foreground. Normal sound playback in the embodiments refers to playing by using a default volume. The normal frame rate in the embodiments refers to playing by using an encoded frame rate in the live video stream. For example, the encoded frame rate in the live video stream is 60 frames per second, and in this case, the video is also played in a manner of 60 frames per second when the live video stream is decoded and played.

The abnormal playback mode is relative to the normal playback mode. In the embodiments, the abnormal playback mode means that the video player silently plays the live video in the background, that is, the video player is hidden in the background and plays the video without making a sound.

In the embodiments, the first video player and the second video player may be created simultaneously when it is detected that the user enters the live room to view the live video. After the two video players are created simultaneously, to avoid mutual interference between the two video players, the attribute of the first video player may be set to the normal playback mode, and the attribute of the second video player may be set to the abnormal playback mode.

In another implementation, the first video player may be first created when it is detected that the user enters the live room to view the live video, and the second video player is created only after that the floating window mode triggered by the user in the live room is enabled is received.

In an example implementation, before the second video player is created, it may be further determined whether the first video player supports the floating window mode. If it is determined that the first video player does not support the floating window mode, the second video player is created. Alternatively, if it is determined that the first video player supports the floating window mode, the second video player is not created.

In an implementation, whether the first video player supports the floating window mode may be determined by determining whether the first video player is a preset video player. The preset player is a preset video player that supports a floating window mode.

As an example, it may be determined whether the first video player is an AVPlayer to determine whether the first video player supports the floating window mode.

In the embodiments, when it is determined that the first video player does not support the floating window mode, the second video player may be created. When it is determined that the first video player supports the floating window mode, the second video player does not need to be created.

It should be noted that after the second video player is created, the second video player may be first hidden in the background for running.

Step S22: Decode and play the live video stream by using the first video player in the normal playback mode, and decode and play the live video stream by using the second video player in the abnormal playback mode.

In some embodiments, after the first video player and the second video player are created, the first video player may directly obtain a downloaded live video stream, and decode and play the live video stream in the normal playback mode at a system front end. In addition, the second video player may directly obtain the downloaded live video stream, and decode and play the live video stream in the abnormal playback mode in a system background.

In an implementation, if the second video player is not created at the same time as the first video player, but is created after the enable instruction of the floating window mode is received, after the second video player is created, the second video player may pull a live video stream of a current live room from the livestreaming server according to an address of the live video stream of the live room, instead of directly obtaining the downloaded live video stream.

In an example implementation, the step of decoding and playing the live video stream by using the second video player in the abnormal playback mode includes:
decoding the live video stream in the background by using the second video player, and silently playing a decoded live picture by using a preset frame rate.

In some embodiments, the preset frame rate is a preset playback frame rate, and the frame rate is a relatively low frame rate. For example, the preset frame rate is 1 frame/s.

In the embodiments, after decoding the live video stream in the background, the second video player silently plays the decoded live picture at an extremely low frame rate, so that performance consumption of the second video player can be reduced.

Step S23: Destroy the first video player when a live room playback page exit instruction triggered by the user is detected, and decode and play the live video stream by using the second video player in the floating window mode and the normal playback mode.

In some embodiments, the live room playback page exit instruction includes an instruction used to switch the live room playback page to an upper-level page, an instruction used to switch the live room playback page to a desktop of a terminal system, and an instruction used to switch the live room playback page to another application.

In some implementations, the upper-level page is the live homepage, and correspondingly, the live room playback page exit instruction is an instruction used to switch the live room playback page to the live homepage. The another application is an APP other that a current livestreaming APP, for example, the another application is a browser APP.

For example, when the user views the live video in the live room, if the user wants to exit a current live playback page to the desktop of the terminal system to perform another operation, the user may trigger an instruction to switch to the desktop of the terminal system by tapping a physical button of a terminal device or a virtual button displayed on a screen. For example, the instruction to switch to the desktop of the terminal system is triggered by tapping a home button. In an implementation, the user may alternatively trigger, by performing a preset slide operation on the screen of the terminal device, the instruction to switch to the desktop of the terminal system. For example, the instruction to switch to the desktop of the terminal system is triggered by sliding upward from an edge of the screen of the terminal device.

In an implementation, when the user-triggered instruction to return to the system desktop is detected, application page viewing or closing may also be displayed, so that the user can view or close a plurality of displayed applications on this page.

The instruction to switch to the desktop of the terminal system is used to exit the livestreaming APP currently running on the front end, and display the system desktop.

For example, when the user views the live video in the live room, if the user wants to exit a current live playback page to the live homepage to perform another operation, the user may trigger an instruction to switch to the live homepage by tapping a physical button of the terminal device or a virtual button displayed on the screen. For example, the user triggers the instruction to switch to the live homepage by tapping the “picture-in-picture playback” button.

As an example, when the user views the live video in the live room, if the user wants to display a page of another APP in a window currently displaying the live room playback page, an instruction to switch to the another application may be triggered by tapping a control displayed in the another APP.

In the embodiments, when detecting the live room playback page exit instruction triggered by the user, the livestreaming APP exits the live room, and normally plays the live video by using the second video player on the front end in the floating window mode, that is, resumes the normal frame rate and sound for video playback. In some embodiments, the downloaded live video stream may be obtained by using the second video player. Then, the downloaded live video stream is decoded. Finally, a parsed live picture is played in the floating window mode.

In the embodiments, the first video player is simultaneously destroyed after the live room playback page is exited. In an implementation, after the live room playback page is exited, the first video player may not be destroyed, but the first video player is only closed in the foreground and hidden in the background for silent playback.

In an implementation, the second video player may also directly pull the live video stream from the livestreaming server. When the second video player successfully pulls a stream from the livestreaming server and obtains the live video stream, the second video player parses the live video stream, and then plays a parsed live picture in the floating window mode.

In an example implementation, referring to FIG. 4, the step of destroying the first video player when a live room playback page exit instruction triggered by the user is detected, and decoding and playing the live video stream by using the second video player in the floating window mode and the normal playback mode may include: Step S50: Destroy the first video player when the live room playback page exit instruction triggered by the user is detected, and create a floating window by using an operating system. Step S51: Decode the live video stream by using the second video player, and play the decoded live picture in the normal playback mode in the floating window.

In some embodiments, the operating system is an operating system of a terminal device. In the embodiments, the operating system is an iOS system. The floating window is a window that is floating. The floating window can display a live picture.

In the embodiments, after the live room is exited, to prevent the first video player from occupying resources, the first video player may be destroyed when the live video stream is decoded and played by using the second video player in the floating window mode, to release the resources occupied by the first video player. In addition, the second video player is hosted on the operating system. Then, the operating system creates the floating window. In this way, the second video player can play the decoded live picture in the normal playback mode in the floating window.

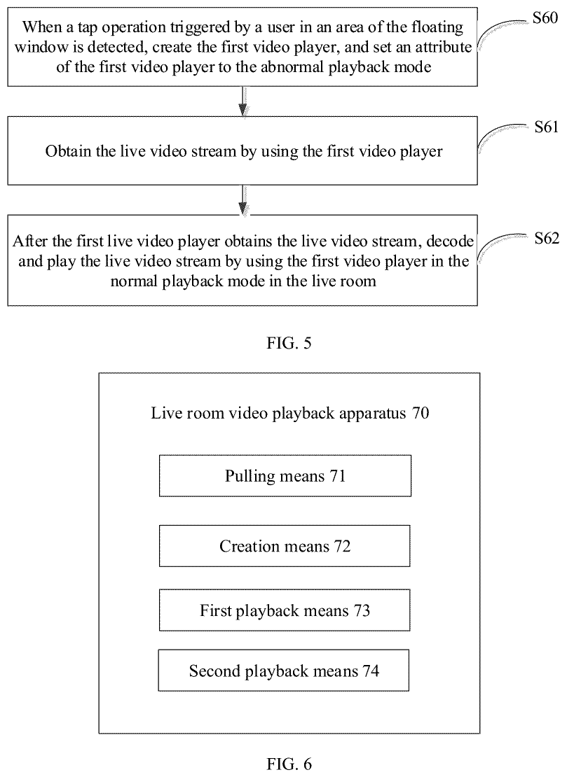

In an example implementation, referring to FIG. 5, after the step of decoding the live video stream by using the second video player, and playing the decoded live picture in the normal playback mode in the floating window, the method further includes:

Step S60: When a tap operation triggered by the user in an area of the floating window is detected, create the first video player, and set the attribute of the first video player to the abnormal playback mode.

In some embodiments, the user may switch the current floating window mode back to a live room playback mode by performing the tap operation in the area of the floating window. In some embodiments, the user may tap any location in the area belonging to the floating window to trigger the current floating window mode to be switched back to the live room playback mode. Alternatively, the user may tap a preset location in the area belonging to the floating window to trigger the current floating window mode to be switched back to the live room playback mode. The preset location is a part of a preset area of the floating window.

In the embodiments, after the tap operation triggered by the user is detected, the first video player is recreated, and the first video player is set to the abnormal playback mode.

Step S61: Obtain the live video stream by using the first video player.

In some embodiments, the first video player pulls the video live stream from the downloaded live video stream after the first video player is recreated.

In an implementation, after the first video player is recreated, the first video player may also pull the live video stream of the live room from the livestreaming server according to the address of the live video stream of the live room.

It may be understood that when the first video player is always in the background and is not destroyed, the first video player does not need to be recreated after the tap operation triggered by the user is detected.

Step S62: After the first live video player obtains the live video stream, decode and play the live video stream by using the first video player in the normal playback mode in the live room.

In some embodiments, after the live video stream is obtained, the live room may be entered, and the live video stream is decoded and played by using the first video player.

In an example implementation, the method further includes:
destroying the second video player.

In some embodiments, to prevent the second video player from occupying resources, the second video player may be destroyed when the live video stream is decoded and played in the live room by using the first video player, to release the resources occupied by the second video player.

In the embodiments, the method includes: pulling a live video stream corresponding to a live room from a preset livestreaming server when it is detected that a user enters a live room playback page; creating a first video player and a second video player, setting an attribute of the first video player to a normal playback mode, and setting an attribute of the second video player to an abnormal playback mode, where the abnormal playback mode is that the second video player silently plays in the background; decoding and playing the live video stream by using the first video player in the normal playback mode, and decoding and playing the live video stream by using the second video player in the abnormal playback mode; and destroying the first video player when a live room playback page exit instruction triggered by the user is detected, and decoding and playing the live video stream by using the second video player in the floating window mode and the normal playback mode. In this application, two video players are simultaneously created when the video is played in the live room. The live video is played in the foreground by using one player, and the live video is played in the background by using the other player. In this way, when the user triggers a return to the system desktop, the live video can be continuously played in the foreground in the floating window mode by using the video player located in the background, improving user experience.

FIG. 6 is a program means diagram of some embodiments of a live room video playback apparatus 70 according to this application.

In the embodiments, the live room video playback apparatus 70 includes a series of computer-readable instructions stored in a memory. When the computer-readable instructions are executed by a processor, live room video playback functions in the embodiments of this application can be implemented. In some embodiments, based on an operation implemented by each part of the computer-readable instructions, the live room video playback apparatus 70 may be divided into one or more means, and may be divided into the following means:
a pulling means 71, configured to pull a live video stream corresponding to a live room from a preset livestreaming server when it is detected that a user enters a live room playback page;
a creation means 72, configured to: create a first video player and a second video player, set an attribute of the first video player to a normal playback mode, and set an attribute of the second video player to an abnormal playback mode, where the abnormal playback mode is that the second video player silently plays in the background;
a first playback means 73, configured to decode and play the live video stream by using the first video player in the normal playback mode, and decode and play the live video stream by using the second video player in the abnormal playback mode; and
a second playback means 74, configured to destroy the first video player when a live room playback page exit instruction triggered by the user is detected, and decode and play the live video stream by using the second video player in a floating window mode and the normal playback mode.

In an example implementation, the first playback means 73 is further configured to decode the live video stream in the background by using the second video player, and silently play a decoded live picture by using a preset frame rate.

In an example implementation, the second playback means 74 is further configured to: destroy the first video player when the live room playback page exit instruction triggered by the user is detected, and create a floating window by using an operating system; and decode the live video stream by using the second video player, and play the decoded live picture in the normal playback mode in the floating window.

In an example implementation, the live room playback page exit instruction includes an instruction used to switch the live room playback page to an upper-level page, an instruction used to switch the live room playback page to a desktop of a terminal system, and an instruction used to switch the live room playback page to another application.

In an example implementation, the live room video playback apparatus 70 further includes an obtaining means.

The creation means 72 is further configured to: when a tap operation triggered by the user in an area of the floating window is detected, create the first video player, and set the first video player to the abnormal playback mode.

The obtaining means is configured to obtain the live video stream by using the first video player.

The first playback means 73 is further configured to: after the first live video player obtains the live video stream, decode and play the live video stream by using the first video player in the normal playback mode in the live room.

In an example implementation, the live room video playback apparatus 70 further includes a destroying means.

The destroying means is configured to destroy the second video player.

In an example implementation, the first video player is an ijkplayer, and the second video player is an AVplayer.

In the embodiments, the apparatus is configured to: pull a live video stream corresponding to a live room from a preset livestreaming server when it is detected that a user enters a live room playback page; create a first video player and a second video player, set an attribute of the first video player to a normal playback mode, and set an attribute of the second video player to an abnormal playback mode, where the abnormal playback mode is that the second video player silently plays in the background; decode and play the live video stream by using the first video player in the normal playback mode, and decode and play the live video stream by using the second video player in the abnormal playback mode; and destroy the first video player when a live room playback page exit instruction triggered by the user is detected, and decode and play the live video stream by using the second video player in a floating window mode and the normal playback mode. In this application, two video players are simultaneously created when the video is played in the live room. The live video is played in the foreground by using one player, and the live video is played in the background by using the other player. In this way, when the user triggers a return to the system desktop, the live video can be continuously played in the foreground in the floating window mode by using the video player located in the background, improving user experience.

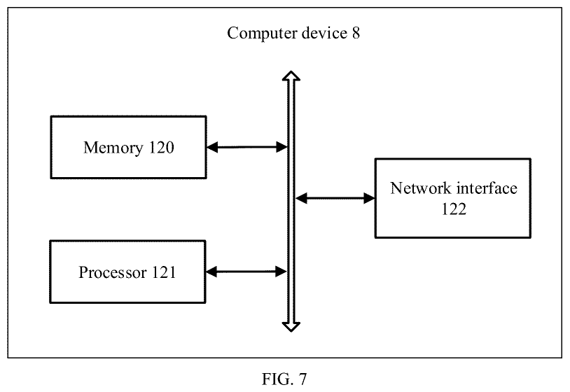

FIG. 7 is a schematic diagram of a hardware architecture of a computer device 8 suitable for implementing a live room video playback method according to some embodiments of this application. In the embodiments, the computer device 8 is a device that can automatically calculate a value and/or process information based on an instruction that is set or stored in advance. For example, the computer device 8 may be a tablet computer, a notebook computer, a desktop computer, a rack server, a blade server, a tower server, a cabinet server (including an independent server, or a server cluster including a plurality of servers), or the like. As shown in FIG. 7, the computer device 8 at least includes but is not limited to a memory 120, a processor 121, and a network interface 122 that can be communicatively connected to each other through a system bus.

The memory 120 includes at least one type of computer-readable storage medium. The readable storage medium may be volatile or non-volatile. In some embodiments, the readable storage medium includes a flash memory, a hard disk, a multimedia card, a card-type memory (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, and the like. In some embodiments, the memory 120 may be an internal storage means of the computer device 8, for example, a hard disk or an internal memory of the computer device 8. In some other embodiments, the memory 120 may be an external storage device of the computer device 8, for example, a removable hard disk, a smart media card (SMC), a secure digital (SD) card, or a flash card that is disposed on the computer device 8. Certainly, the memory 120 may include both an internal storage means of the computer device 8 and an external storage device of the computer device 8. In the embodiments, the memory 120 is generally configured to store an operating system and various application software that are installed on the computer device 8, for example, program code of the live room video playback method. In addition, the memory 120 may be further configured to temporarily store various types of data that have been output or are to be output.

In some embodiments, the processor 121 may be a central processing unit (CPU), a controller, a microcontroller, a microprocessor, or another live room video playback chip. The processor 121 is usually configured to control an overall operation of the computer device 8, for example, perform control and processing related to data exchange or communication performed by the computer device 8. In the embodiments, the processor 121 is configured to run program code stored in the memory 120 or process data.

The network interface 122 may include a wireless network interface or a wired network interface, and the network interface 122 is usually configured to establish a communication link between the computer device 8 and another computer device. For example, the network interface 122 is configured to connect the computer device 8 to an external terminal by using a network, to establish a data transmission channel and a communication link between the computer device 8 and the external terminal. The network may be a wireless or wired network such as an intranet, the Internet, a global system for mobile communications (GSM), wideband code division multiple access (WCDMA), a 4G network, a 5G network, Bluetooth, or Wi-Fi.

It should be noted that FIG. 7 shows only a computer device with the components 120 to 122. However, it should be understood that implementation of all the shown components is not required, and more or fewer components may alternatively be implemented.

In the embodiments, the live room video playback method stored in the memory 120 may be further divided into one or more program means to be executed by one or more processors (the processor 121 in the embodiments), to complete this application.

Some embodiments of this application provides a computer-readable storage medium, storing computer-readable instructions, and the computer-readable instructions are executed by a processor to implement the steps of the live room video playback method in the embodiments.

In the embodiments, the computer-readable storage medium includes a flash memory, a hard disk, a multimedia card, a card-type memory (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, or the like. In some embodiments, the computer-readable storage medium may be an internal storage unit of a computer device, for example, a hard disk or an internal memory of the computer device. In some other embodiments, the computer-readable storage medium may be an external storage device of the computer device, for example, a removable hard disk, a smart media card (SMC), a secure digital (SD) card, or a flash card that is disposed on the computer device. Certainly, the computer-readable storage medium may alternatively include both an internal storage unit of the computer device and an external storage device of the computer device. In the embodiments, the computer-readable storage medium is generally configured to store an operating system and various application software that are installed on the computer device, for example, program code of the live room video playback method in the embodiments. In addition, the computer-readable storage medium may be further configured to temporarily store various types of data that have been output or are to be output.

The apparatus embodiments described above are only examples, and units described as separate parts may or may not be physically separated, and parts displayed as units may or may not be physical units, that is, may be located at one position, or may be distributed on at least two network units. Some or all of the means may be selected based on an actual need to achieve the objective of the solutions of the embodiments of this application. Persons of ordinary skill in the art may understand and implement the embodiments without creative efforts.

Based on the foregoing descriptions of the implementations, persons of ordinary skill in the art may clearly understand that the implementations may be implemented by software in addition to a universal hardware platform, or certainly, may be implemented by hardware. Persons of ordinary skill in the art can understand that all or some of the processes in the methods in the foregoing embodiments may be implemented by instructing related hardware by using computer-readable instructions. The program may be stored in a computer-readable storage medium. The processes of the embodiments of the methods may be performed when the program is executed. The storage medium may be a magnetic disk, an optical disc, a read-only memory (ROM), a random access memory (RAM), or the like.

Finally, it should be noted that the foregoing embodiments are merely intended for describing the technical solutions of this application, but not for limiting this application. Although this application is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of this application.

What is claimed is:

1. A method, comprising:
in response to detecting that a user enters a live room playback page, pulling a live video stream corresponding to a live room from a preset livestreaming server;
creating a first video player and a second video player, setting an attribute of the first video player to a normal playback mode, and setting an attribute of the second video player to an abnormal playback mode, wherein the abnormal playback mode is that the second video player silently plays in background;
decoding and playing the live video stream by using the first video player in the normal playback mode, and decoding and playing the live video stream by using the second video player in the abnormal playback mode; and
in response to detecting a live room playback page exit instruction triggered by the user, destroying the first video player, and decoding and playing the live video stream by using the second video player in a floating window mode and the normal playback mode.

2. The method according to claim 1, wherein decoding and playing the live video stream by using the second video player in the abnormal playback mode comprises:
decoding the live video stream in the background by using the second video player, and silently playing a decoded live picture by using a preset frame rate.

3. The method according to claim 1, wherein in response to detecting the live room playback page exit instruction triggered by the user, destroying the first video player, and decoding and playing the live video stream by using the second video player in the floating window mode and the normal playback mode comprises:
in response to detecting the live room playback page exit instruction triggered by the user, destroying the first video player, and creating a floating window by using an operating system; and
decoding the live video stream by using the second video player, and playing the decoded live picture in the normal playback mode in the floating window.

4. The method according to claim 3, wherein the live room playback page exit instruction comprises an instruction used to switch the live room playback page to an upper-level page, an instruction used to switch the live room playback page to a desktop of a terminal system, and an instruction used to switch the live room playback page to another application.

5. The method according to claim 3, after the step of decoding the live video stream by using the second video player, and playing the decoded live picture in the normal playback mode in the floating window, the method further comprising:
in response to detecting a tap operation triggered by the user in an area of the floating window, creating the first video player, and setting the attribute of the first video player to the abnormal playback mode;
obtaining the live video stream by using the first video player; and
after the first live video player obtains the live video stream, decoding and playing the live video stream by using the first video player in the normal playback mode in the live room.

6. The method according to claim 5, further comprising:
destroying the second video player.

7. The method according to claim 1, wherein the first video player is an ijkplayer, and the second video player is an AVplayer.

8. A computing device, comprising:
one or more processors; and
a memory, storing one or more programs configured to be executed by the one or more processors, the one or more programs comprising instructions for:
in response to detecting that a user enters a live room playback page, pulling a live video stream corresponding to a live room from a preset livestreaming server;
creating a first video player and a second video player, setting an attribute of the first video player to a normal playback mode, and setting an attribute of the second video player to an abnormal playback mode, wherein the abnormal playback mode is that the second video player silently plays in a background;
decoding and playing the live video stream by using the first video player in the normal playback mode, and decoding and playing the live video stream by using the second video player in the abnormal playback mode; and
in response to detecting a live room playback page exit instruction triggered by the user, destroying the first video player, and decoding and playing the live video stream by using the second video player in a floating window mode and the normal playback mode.

9. The computing device according to claim 8, wherein decoding and playing the live video stream by using the second video player in the abnormal playback mode comprises:
decoding the live video stream in the background by using the second video player, and silently playing a decoded live picture by using a preset frame rate.

10. The computing device according to claim 8, wherein in response to detecting the live room playback page exit instruction triggered by the user, destroying the first video player, and decoding and playing the live video stream by using the second video player in the floating window mode and the normal playback mode comprises:
in response to detecting the live room playback page exit instruction triggered by the user, destroying the first video player, and creating a floating window by using an operating system; and
decoding the live video stream by using the second video player, and playing the decoded live picture in the normal playback mode in the floating window.

11. The computing device according to claim 10, wherein the live room playback page exit instruction comprises an instruction used to switch the live room playback page to an upper-level page, an instruction used to switch the live room playback page to a desktop of a terminal system, and an instruction used to switch the live room playback page to another application.

12. The computing device according to claim 10, wherein the one or more programs further comprise instructions for:
after the step of decoding the live video stream by using the second video player, and playing the decoded live picture in the normal playback mode in the floating window,
in response to detecting a tap operation triggered by the user in an area of the floating window, creating the first video player, and setting the attribute of the first video player to the abnormal playback mode;
obtaining the live video stream by using the first video player; and
after the first live video player obtains the live video stream, decoding and playing the live video stream by using the first video player in the normal playback mode in the live room.

13. The computing device according to claim 12, wherein the one or more programs further comprise instructions for:
destroying the second video player.

14. The computing device according to claim 8, wherein the first video player is an ijkplayer, and the second video player is an AVplayer.

15. A non-transitory computer-readable storage medium, wherein the non-transitory computer-readable storage medium stores one or more programs comprising instructions that, when executed by one or more processors of a computing device, cause the computing device to perform operations comprising:
in response to detecting that a user enters a live room playback page, pulling a live video stream corresponding to a live room from a preset livestreaming server;
creating a first video player and a second video player, setting an attribute of the first video player to a normal playback mode, and setting an attribute of the second video player to an abnormal playback mode, wherein the abnormal playback mode is that the second video player silently plays in a background;
decoding and playing the live video stream by using the first video player in the normal playback mode, and decoding and playing the live video stream by using the second video player in the abnormal playback mode; and
in response to detecting a live room playback page exit instruction triggered by the user, destroying the first video player, and decoding and playing the live video stream by using the second video player in a floating window mode and the normal playback mode.

16. The non-transitory computer-readable storage medium according to claim 15, wherein decoding and playing the live video stream by using the second video player in the abnormal playback mode comprises:
decoding the live video stream in the background by using the second video player, and silently playing a decoded live picture by using a preset frame rate.

17. The non-transitory computer-readable storage medium according to claim 15, wherein in response to detecting the live room playback page exit instruction triggered by the user, destroying the first video player, and decoding and playing the live video stream by using the second video player in the floating window mode and the normal playback mode comprises:
in response to detecting the live room playback page exit instruction triggered by the user, destroying the first video player, and creating a floating window by using an operating system; and
decoding the live video stream by using the second video player, and playing the decoded live picture in the normal playback mode in the floating window.

18. The non-transitory computer-readable storage medium according to claim 17, wherein the live room playback page exit instruction comprises an instruction used to switch the live room playback page to an upper-level page, an instruction used to switch the live room playback page to a desktop of a terminal system, and an instruction used to switch the live room playback page to another application.

19. The non-transitory computer-readable storage medium according to claim 17, the operations further comprising:
after the step of decoding the live video stream by using the second video player, and playing the decoded live picture in the normal playback mode in the floating window,
in response to detecting a tap operation triggered by the user in an area of the floating window, creating the first video player, and setting the attribute of the first video player to the abnormal playback mode;
obtaining the live video stream by using the first video player; and
after the first live video player obtains the live video stream, decoding and playing the live video stream by using the first video player in the normal playback mode in the live room.

20. The non-transitory computer-readable storage medium according to claim 19, the operations further comprising:
destroying the second video player.
